(19) United States
(12) Patent Application Publication
(10) Pub. No.: US 2007/0189036 A1
(43) Pub. Date: Aug. 16, 2007

(54) Backlight module

(75) Inventors: Ping-Yeng Chen, Feng Yuan City (TW); Kuo-Jui Huang, Ta Li City (TW)

Correspondence Address: BIRCH STEWART KOLASCH & BIRCH, PO BOX 747, FALLS CHURCH, VA, 22040-0747, US

(73) Assignee: WINTEK CORPORATION

(21) Appl. No.: 11/647,447

(22) Filed: Dec. 29, 2006

(30) Foreign Application Priority Data
Feb. 10, 2006 (TW) 095104459

(51) Int. Cl. F21V 7/04

(52) U.S. Cl. 362/613

(57) ABSTRACT

A backlight module includes a light guide plate, a bar member, and two point light sources. The bar member is connected to one side of the light guide plate with a slot being formed between them. The bar member has a light emitting surface facing the light receiving surface of the light guide plate and a light reflecting surface opposite to the light emitting surface, and the light emitting surface and the light receiving surface are spaced apart from each other by the slot. The light receiving surface of the light guide plate and the light emitting surface of the bar member are both bent toward or away from the light reflecting surface.

### BACKGROUND OF THE INVENTION

(a) Field of the Invention

The invention relates to a backlight module, and particularly to a backlight module in which a point light source is converted into a linear light source having improved light utilization efficiency.

(b) Description of the Related Art

Typically, a linear light source such as a cold-cathode fluorescent lamp (CCFL) is often used in a backlight module; however, it is bulky and thus not suitable for a compact electronic product such as a handheld display. In contrast, a point light source such as a light emitting diode (LED) is fit for such kind of electronic product due to its small size.

FIG. 1 shows a schematic diagram illustrating a conventional backlight module using a point light source. Referring to FIG. 1, two light emitting diodes 11 are positioned next to one side of a light guide plate 10 and spaced apart from each other a predetermined distance. As to a point light source, the relationship between the radiant power and the angle between the observer's line of sight and the surface normal is governed by the Lambert's emission law, so multiple dark zones A having comparatively low brightness often emerge on the light guide plate 10 to result in inferior luminance uniformity, as shown in FIG.1

In order to eliminate the dark zones, a typical method is to provide a light deflecting structure, such as a V-shaped or a trapezoidal-shaped notch, on the light receiving surface 12 of the light guide plate 10 to diffuse the emitting light of the point light source before propagating inside the light guide plate 10. However, this approach has limited effect on the elimination of dark zones.

Hence, U.S. Pat. No. 6,474,826 discloses a lighting apparatus to overcome the problem described above. As shown in FIG. 2, the lighting apparatus includes a light guide plate 20 and a light source rod 21 that are integrally formed as one piece with a rectangular slot 23 formed between them. The LEDs 22 are positioned next to two longitudinal ends of the light source rod 21, so that the emitting light of the LEDs 22 may spread in the light source rod 21 before entering the light guide plate 20 to have the light source rod 21 function as a linear light source.

However, in case the size of a light guide plate is reduced to fit a compact electronic product such as a handheld display, the light utilization efficiency of the lighting apparatus shown in FIG. 2 is often inferior. This is because a shorter width W of the light guide plate 20, which also means a shorter length of the light source rod 21, may reduce the probability that the emitting light of the LEDs 22 strikes the light deflecting elements provided on the light reflecting surface 21a of the light source rod 21. Also, in the conventional design shown in FIG. 2, the distance H between the light reflecting surface 21a and the rectangular slot 23 is not long enough to provide sufficient space for the propagation of light in the light source rod 21, which in turns reduces the probability that the emitting light of the LEDs 22 strikes the light deflecting elements to further reduce the light utilization efficiency.

### BRIEF SUMMARY OF THE INVENTION

In order to solve the above-mentioned drawbacks, an object of the invention is to provide a backlight module in which a point light source is converted into a linear light source having improved light utilization efficiency.

Another object of the invention is to provide a backlight module capable of providing high luminance efficiency and good uniformity.

According to the invention, a backlight module includes a light guide plate, a bar member, and two point light sources respectively positioned next to two longitudinal sides of the bar member. The bar member is connected to one side of the light guide plate with a slot being formed between them. The bar member has a light emitting surface facing the light receiving surface of the light guide plate and a light reflecting surface opposite to the light emitting surface, and the light emitting surface of the bar member and the light receiving surface of the light guide plate are spaced apart from each other by the slot. The light reflecting surface of the bar member reflects the emitting light of the point light sources to the light emitting surface of the bar member, and the light receiving surface of the light guide plate and the light emitting surface of the bar member are both bent toward or away from the light reflecting surface. The light guide plate and the bar member may be integrally formed as one piece, and the slot may be V-shaped or arc-shaped.

Through the design of the invention, since the light emitting surface of the bar member is bent toward the light reflecting surface of the bar member, the bar member is shaped as two trapezoidal bodies positioned side by side to provide more space for light propagation. Thus, the emitting light of the point light source is fully utilized and evenly distributed inside the light guide plate to result in high luminance efficiency and good uniformity. Also, compared with the conventional design where a portion of the emitting light of the point light source fails to be deflected out of a flat light source rod, the V-shaped or arc-shaped light emitting surface of the invention may correct the propagation angle of that portion of the emitting light to allow it to enter the light guide plate at an azimuth angle of zero degree so as to result in high luminance efficiency and good uniformity.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic diagram illustrating a design of a conventional backlight module.

FIG. 2 shows a schematic diagram illustrating another design of a conventional backlight module.

FIG. 3 shows a schematic diagram illustrating a backlight module according to an embodiment of the invention.

FIG. 4 shows a schematic diagram illustrating a backlight module according to another embodiment of the invention.

FIG. 5 shows a schematic diagram illustrating a backlight module according to another embodiment of the invention.

FIG. 6 shows a schematic diagram illustrating the light path according to the embodiment shown in FIG. 4.

FIG. 7 shows a schematic diagram illustrating a backlight module according to another embodiment of the invention.

FIG. 8 shows a schematic diagram illustrating a backlight module according to another embodiment of the invention.

FIG. 9 shows a schematic diagram illustrating a backlight module according to another embodiment of the invention.

FIGS. 10, 11A, 11B and 12 shows schematic diagrams illustrating the angular relationships in a conventional design and in the embodiment shown in FIG. 9, which are used to explain the effect of improving light utilization efficiency according to the invention.

FIG. 13 shows a schematic diagram illustrating a backlight module according to another embodiment of the invention.

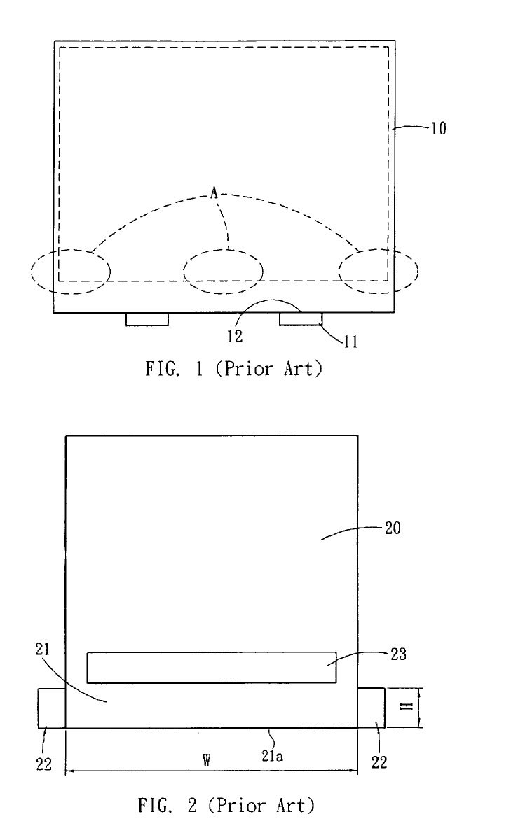

### DETAILED DESCRIPTION OF THE INVENTION

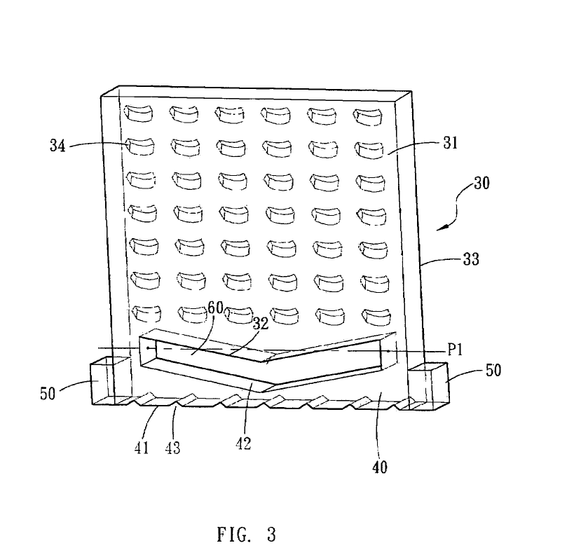

FIG. 3 shows a schematic diagram illustrating a backlight module according to an embodiment of the invention. As shown in FIG. 3, the backlight module having a point light source includes a light guide plate 30, a bar member 40 and two light emitting diodes 50. The light guide plate 30 has a light receiving surface 32, a light emitting surface 31 perpendicular to the light-receiving surface 32, and a bottom surface 33 opposite to the light emitting surface 31. A plurality of light deflecting elements 34 for diffusing light transmitted into the light guide plate 30 are formed on either the light emitting surface 31 or the bottom surface 33, or both. The emitting light of the light emitting diodes 50 are confined in the light guide plate 30 and diffused by the light deflecting elements 34 to allow for surface emission radiated from the light emitting surface 31 of the light guide plate 30. The light deflecting elements 34 may be grooves or notches formed on the plate surface.

The bar member 40 is connected to one side of the light guide plate 30 with a slot 60 formed between them. The bar member 40 has a light emitting surface 42 facing the light receiving surface 32 of the light guide plate 30 and a side surface 41 opposite to the light emitting surface 42, and its light emitting surface 42 and the light receiving surface 32 of the light guide plate 30 are spaced apart from each other by the slot 60. A plurality of light deflecting elements 43 are provided on the side surface 41 for diffusing the emitting light of the light emitting diodes 50, so the side surface 41 functions as a light reflecting surface of the bar member 40. Also, the light deflecting elements 43 may be grooves or notches formed on the light reflecting surface of the bar member 40.

Two light emitting diodes 50 used for providing source light are positioned next to two opposite longitudinal ends of the bar member 40, respectively. The emitting light of the light emitting diodes 50 propagating in the bar member 40 before entering the light guide plate 30 causes the bar member 40 to become a linear light source.

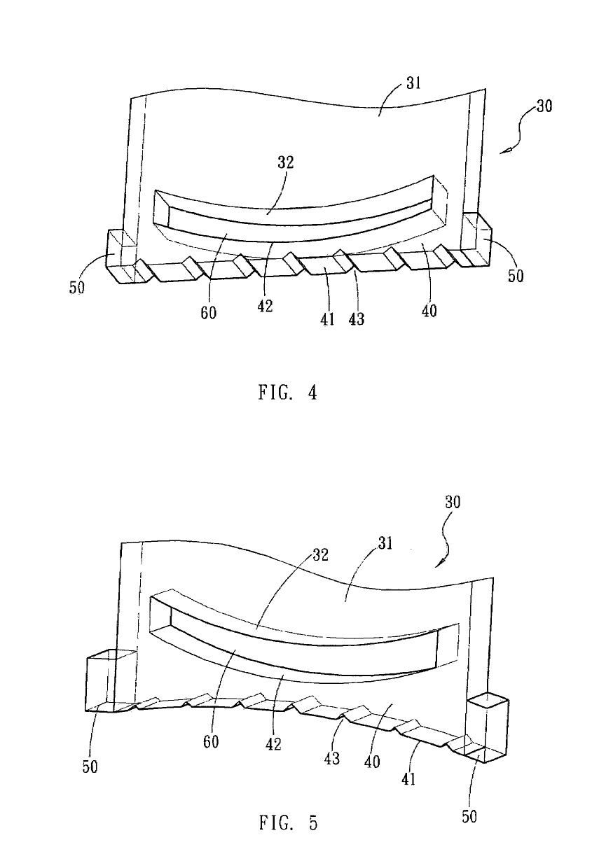

In this embodiment, the light emitting surface 42 of the bar member 40 and the light receiving surface 32 of the light guide plate 30 are both bent toward the light reflecting surface 41 of the bar member 40 to define a V-shaped slot 60, as shown in FIG. 3. In other words, in case a connecting line of two opposite longitudinal ends of the V-shaped slot 60 is defined as a reference axis P1, the center potion of the light receiving surface 32 and that of the light emitting surface 42 both deviate from the reference axis P1 along the same direction, and the center portion of the slot 60 is positioned nearer the light reflecting surface 41 of the bar member 40 compared with its two longitudinal ends. In an alternate embodiment, the light emitting surface 42 of the bar member 40 and the light receiving surface 32 of the light guide plate 30 are both bent toward the light reflecting surface 41 of the bar member 40 to define an arc-shaped slot 60, as shown in FIG. 4. Also, referring to FIG. 3 and FIG. 4, the slot 60 is extended to have its two longitudinal ends be located close to two longitudinal ends of the bar member 40, respectively.

Further, the light guide plate 30 and the bar member 40 may be integrally formed as one piece and made from polymethyl methacrylate (PMMA). Besides, the light reflecting surface 41 may be a flat surface shown in FIG. 4 or a curved surface shown in FIG. 5.

Typically, a light guide plate is often designed as a trapezoidal shape to provide more space for light propagation, and, in that case, the total length of light path through which the light travels inside the light guide plate is increased to improve the light utilization efficiency.

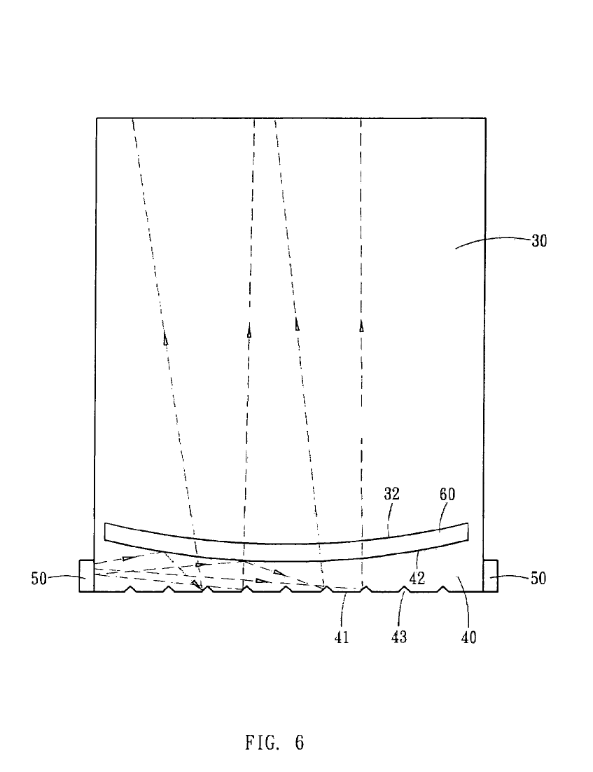

Hence, as shown in FIG. 6, since the light emitting surface 42 of the bar member 40 is bent toward the light reflecting surface 41 of the bar member 40, the bar member 40 is shaped as two trapezoidal bodies positioned side by side to provide more space for light propagation. Thus, the portion of the emitting light of the light emitting diodes 50 that fails to be deflected out of the rectangular slot 23 shown in FIG. 2 can be reflected by the V-shaped or arc-shaped light emitting surface 42 to the light reflecting surface 41 according to the invention, and then it is directed to the light guide plate 30 by the light deflecting elements 43 formed on the light reflecting surface 41, with the azimuth angle of that portion of the emitting light being effectively changed by the light deflecting elements 43 to a proper angle that allows it to be deflected out of the slot 60. Thus, through the design of the invention, the emitting light of the light emitting diodes 50 is fully utilized and evenly distributed inside the light guide plate 30 to result in high luminance efficiency and good uniformity.

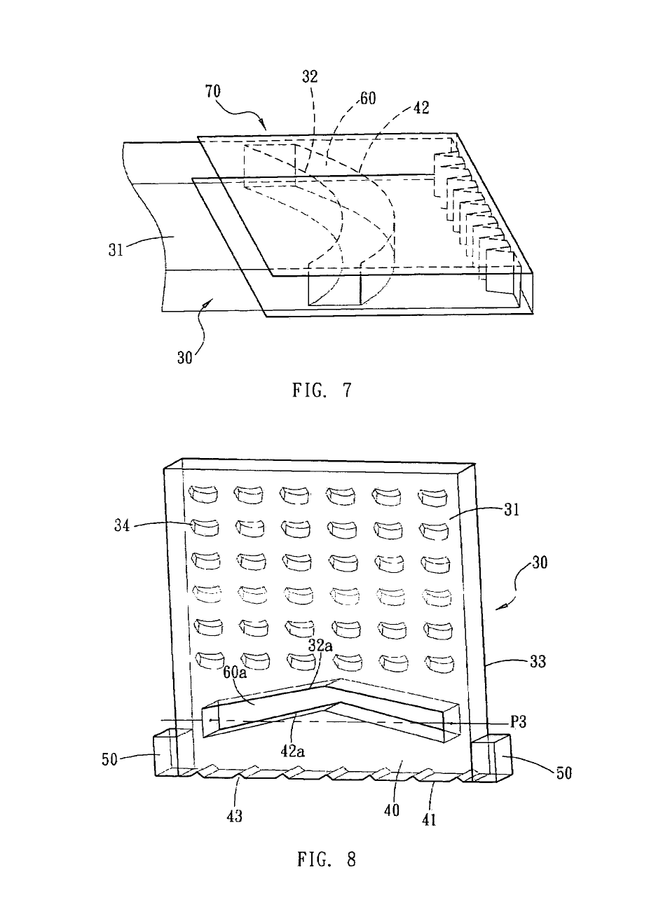

FIG. 7 shows a schematic diagram illustrating another embodiment of the invention. Referring to FIG. 7, a light-recycling means 70 is additionally provided to surround the light guide plate 30 and the bar member 40. The light-recycling means 70 is constructed by reflecting plates that cover the top and bottom surfaces of the bar member 40 and the slot 60 to reflect back the light leaking from these places so as to further improve the luminance efficiency.

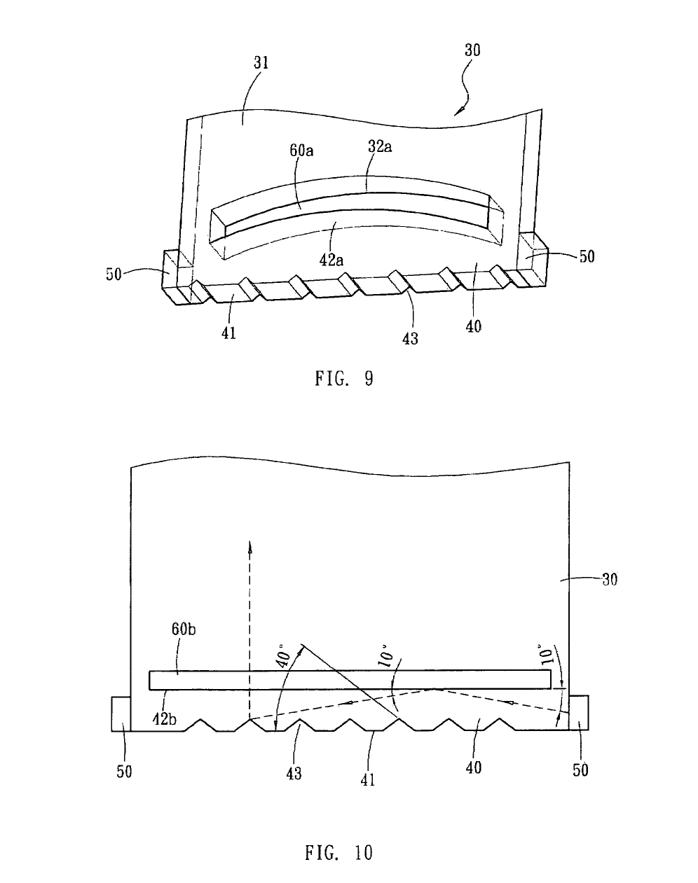

FIG. 8 and FIG. 9 show schematic diagrams illustrating another embodiments of the invention. The components shown in FIG. 8 and FIG. 9, including the light guide plate 30, the bar member 40, and the light emitting diodes 50, are the same as those shown in FIG. 3, except the bending direction of the slot 60 is changed. Referring to FIG. 8, the light emitting surface 42a of the bar member 40 and the light receiving surface 32a of the light guide plate 30 are both bent away from the light reflecting surface 41 of the bar member 40 to define a V-shaped slot 60a. In other words, in case a connecting line of two opposite longitudinal ends of the V-shaped slot 60a is defined as a reference axis P3, the center potion of the light receiving surface 32a and that of the light emitting surface 42a both deviate from the reference axis P3 along the same direction, and two longitudinal ends of the slot 60a are positioned nearer the light reflecting surface 41 of the bar member 40 compared with its center portion. Besides, the light reflecting surface 41 of the bar member 40 is a flat surface on which a plurality of light reflecting elements 43 are formed. Further, referring to FIG. 9, the light emitting surface 42a and the light receiving surface 32a are also both bent away from the light reflecting surface 41 of the bar member 40 to define an arc-shaped slot 60a.

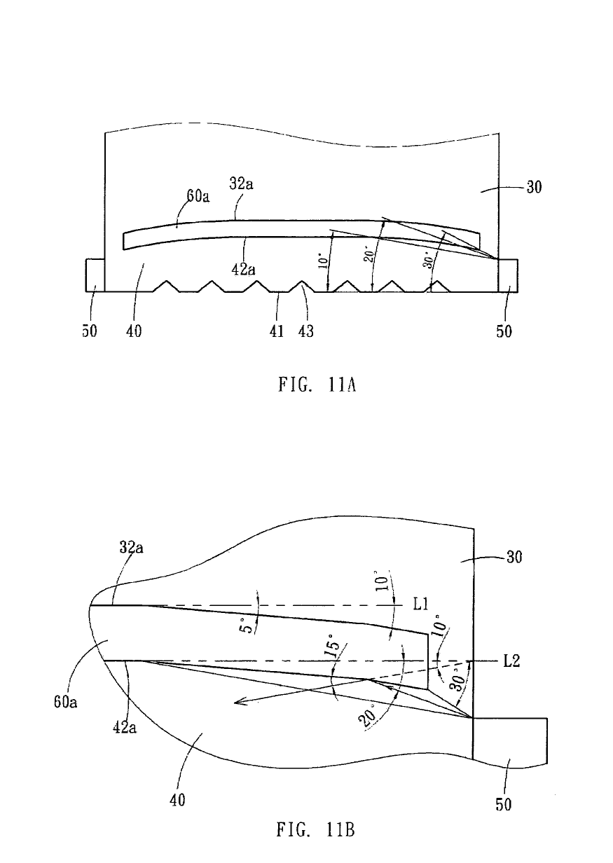

FIGS. 10 to 12 shows schematic diagrams illustrating the angular relationships in a conventional design and in the embodiment shown in FIG. 9, which are used to explain the effect of improving light utilization efficiency according to the invention.

First, in the conventional design shown in FIG. 10, the slot 60b has a rectangular shape defined by two parallel flat surfaces, the light-emitting element is a point light source 50, and all the light deflecting elements 43 formed on the light reflecting surface 41 are the same. Assume the light incident surface of the light deflecting element 43 makes an angle of about 40 degrees with the light reflecting surface 41 and the emitting light of the point light source 50 strikes the flat light emitting surface 42b at an angle of 10 degrees (i.e., the angle made with the horizontal), the light that is sequentially deflected by the light deflecting elements 43 and the slot 60b is directed to the light guide plate 30 at an azimuth angle of zero degree (i.e., propagating perpendicular to the light reflecting surface 41).

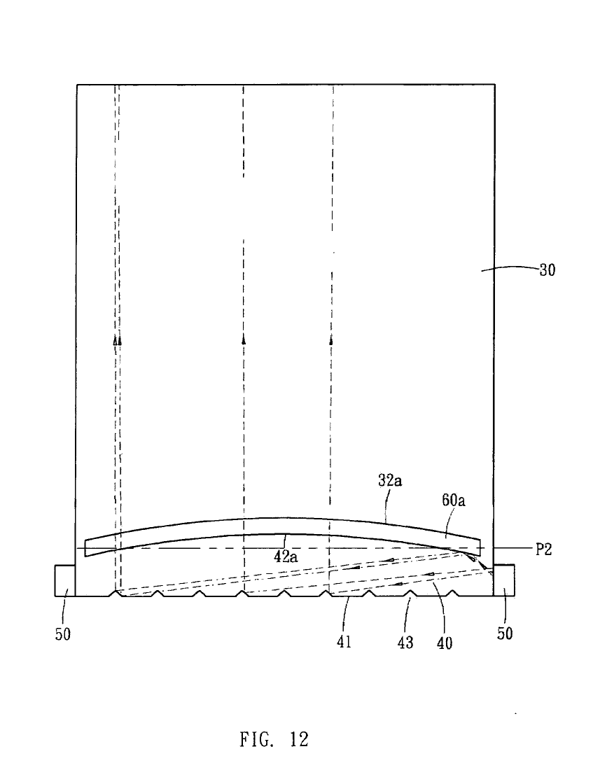

In comparison, according to an embodiment of the invention, the light emitting surface 42a is bent away from the light reflecting surface 41 so that it make different angles with the horizontal on its different positions, as shown in FIG. 11A. Thus, under the same conditions described above, assume the light incident surface of the light deflecting elements 43 makes an angle of about 40 degrees with the light reflecting surface 41 and the emitting light of the point light source 50 propagates at an angle of 10 degrees with respect to the horizontal, the light that is sequentially deflected by the light deflecting elements 43 and the slot 60a enters the light guide plate 30 at an azimuth angle of zero degree. On the other hand, in case the emitting light of the point light source 50 propagates at an angle larger than 10 degrees with respect to the horizontal, the bent surface can provide angle variation to counterbalance the variation in the incident angle of the emitting light so as to have the emitting light strike the light emitting surface 42a still at an angle of about 10 degrees.

More specifically, as shown in the partial enlarged view of FIG. 11B, if the emitting light of the point light source 50 that propagates at an angle of 20 degrees with respect to the horizontal incidents to the bent light emitting surface 42a that makes an angle of 5 degrees with the horizontal line L1, the incident light will be reflected at an angle of about 10 degrees with respect to the horizontal line L2, which is similar to the condition where the emitting light is incident to a flat light emitting surface 42a at an angle of 10 degrees. Thus, the light that enters the light guide plate 30 may maintain at an azimuth angle of zero degree (i.e., propagating perpendicular to light reflecting surface 41). Also, the bending angle of the light emitting surface 42a can be modified according to the distance from it to the point light source 50 to obtain optimal luminance efficiency. Besides, the deflecting angle of each light deflecting elements 43 can vary according to the distance from it to the point light source 50 so as to provide different light intensity values on separate zones of the light guide plate 30.

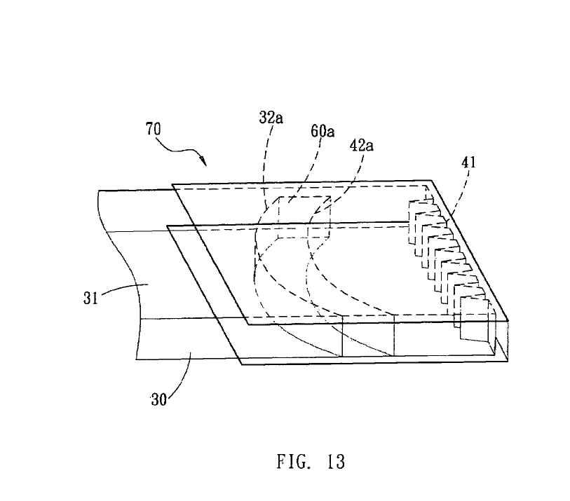

As shown in FIG. 12, when most of the emitting light beams of the point light source 50 strike the light emitting surface 42a of the bar member 40 at an incident angle of about 10 degrees, the light entering the light guide plate 30 may have an azimuth angle of zero degree to cause maximum light intensity. Certainly, a fine tune on the bending angle of the light emitting surface 42a may further improve the light utilization efficiency. Compared with the conventional design where a portion of the emitting light of the point light source 22 fails to be deflected out of a flat light source rod shown in FIG. 2, the V-shaped or arc-shaped light emitting surface 42a of the invention may correct the propagation angle of that portion of the emitting light to allow it to enter the light guide plate 30 at an azimuth angle of zero degree so as to result in high luminance efficiency and good uniformity.

FIG. 13 shows a schematic diagram illustrating another embodiment of the invention. Referring to FIG. 13, a light-recycling means 70 is additionally provided to surround the light guide plate 30 and the bar member 40, where a slot 60a is bent away from the light reflecting surface 41. The light-recycling means 70 is constructed by reflecting plates that cover the top and bottom surfaces of the bar member 40 and the slot 60a to reflect back the light leaking from these places so as to further improve the luminance efficiency.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A backlight module, comprising:
a light guide plate having a light receiving surface;
a bar member connected to one side of the light guide plate with a slot being formed between them, the bar member having a light emitting surface facing the light receiving surface of the light guide plate, and the light emitting surface and the light receiving surface being spaced apart from each other by the slot; and
two point light sources respectively positioned next to two longitudinal ends of the bar member;
wherein the light receiving surface of the light guide plate and the light emitting surface of the bar member are both bent in the same direction.

2. The backlight module as claimed in claim 1, wherein the bar member has a side surface opposite to the light emitting surface, and the light receiving surface of the light guide plate and the light emitting surface of the bar member are both bent toward the side surface.

3. The backlight module as claimed in claim 1, wherein the bar member has a side surface opposite to the light emitting surface, and the light receiving surface of the light guide plate and the light emitting surface of the bar member are both bent away from the side surface.

4. The backlight module as claimed in claim 1, further comprising a plurality of light deflecting elements formed on the side surface for directing the emitting light of the point light sources to the light guide plate.

5. The backlight module as claimed in claim 1, wherein the light guide plate and the bar member are integrally formed as one piece.

6. The backlight module as claimed in claim 1, wherein the slot is V-shaped or arc-shaped.

7. The backlight module as claimed in claim 1, wherein the bar member is shaped as two trapezoidal bodies positioned side by side.

8. The backlight module as claimed in claim 1, further comprising a light-recycling means that surrounds the light guide plate and the bar member and is constructed by reflecting plates.

9. A backlight module, comprising:
a light guide plate having a light receiving surface;
a bar member connected to one side of the light guide plate with a slot being formed between them, the bar member having a light emitting surface facing the light receiving surface of the light guide plate and having a light reflecting surface opposite to the light emitting surface, and the light emitting surface of the bar member and the light receiving surface of the light guide plate being spaced apart from each other by the slot; and
two point light sources respectively positioned next to two longitudinal sides of the bar member;
wherein the light reflecting surface reflects the emitting light of the point light sources to the light emitting surface of the bar member, and the light receiving surface of the light guide plate and the light emitting surface of the bar member are both bent toward or away from the light reflecting surface.

10. The backlight module as claimed in claim 9, wherein the light guide plate and the bar member are integrally formed as one piece.

11. The backlight module as claimed in claim 9, wherein the slot is V-shaped or arc-shaped.

12. The backlight module as claimed in claim 9, wherein the bar member is shaped as two trapezoidal bodies positioned side by side.

13. The backlight module as claimed in claim 9, further comprising a light-recycling means that surrounds the light guide plate and the bar member and is constructed by reflecting plates.

14. The backlight module as claimed in claim 9, wherein the light reflecting surface is a flat surface or a curved surface.

15. The backlight module as claimed in claim 9, further comprising a plurality of first light deflecting elements formed on the light guide plate and a plurality of second light deflecting elements formed on the bar member.

16. The backlight module as claimed in claim 15, wherein the light guide plate has a light emitting surface perpendicular to the light receiving surface and a bottom surface opposite to the light emitting surface, the first light deflecting elements are formed on the bottom surface or the light emitting surface of the light guide plate, and the second light deflecting elements are formed on the reflecting surface of the bar member.

17. A backlight module, comprising:
a light guide plate having a light receiving surface, a light emitting surface perpendicular to the light receiving surface, and a bottom surface opposite to the light emitting surface;
a bar member connected to one side of the light guide plate with a slot being formed between them, the bar member having a light emitting surface facing the light receiving surface of the light guide plate and a light reflecting surface opposite to the light emitting surface, and the light emitting surface and the light receiving surface being spaced apart from each other by the slot; and
two point light sources respectively positioned next to two longitudinal sides of the bar member;
wherein a connecting line of two opposite longitudinal ends of the slot is defined as a reference axis, and the center portion of the light receiving surface of the light guide plate and the center portion of the light emitting surface of the bar member both deviate from the reference axis along the same direction.

18. The backlight module as claimed in claim 17, wherein the light guide plate and the bar member are integrally formed as one piece.

19. The backlight module as claimed in claim 17, wherein the slot is V-shaped or arc-shaped.

20. The backlight module as claimed in claim 17, wherein the bar member is shaped as two trapezoidal bodies positioned side by side.

21. The backlight module as claimed in claim 17, further comprising a light-recycling means that surrounds the light guide plate and the bar member and is constructed by reflecting plates.

22. The backlight module as claimed in claim 17, further comprising a plurality of first light deflecting elements formed on the light guide plate and a plurality of second light deflecting elements formed on the bar member.
